(19) United States
(12) Patent Application Publication
(10) Pub. No.: US 2023/0325677 A1
(43) Pub. Date: Oct. 12, 2023

(54) LEARNING SYSTEM, LEARNING METHOD, AND COMPUTER PROGRAM

(71) Applicant: NEC Corporation, Minato-ku, Tokyo (JP)

(72) Inventor: Takahiro Toizumi, Tokyo (JP)

(73) Assignee: NEC Corporation, Minato-ku, Tokyo (JP)

(21) Appl. No.: 18/023,559

(22) PCT Filed: Sep. 2, 2020
(86) PCT No.: PCT/JP2020/033195

§ 371 Date: Feb. 27, 2023

(51) Int. Cl. G06N 3/094; G06N 3/0475

(52) U.S. Cl. CPC G06N 3/094; G06N 3/0475

(57) ABSTRACT

A learning system includes: a training data generation unit that extracts a constraint of an inputted layout and that generates constrained training data; and a learning unit that learns, by using Generative Adversarial Networks, a learning unit that generates a generated layout by using a random number and a layout discrimination unit that discriminates the generated layout and the constrained training data. According to such a learning system, it is possible to properly learn the layout in a document or the like.

### TECHNICAL FIELD

This disclosure relates to a learning system, a learning method, and a computer program that perform learning about a layout.

### BACKGROUND

For example, a known technique/technology is to automatically generate a layout in a document such as a newspaper and a magazine. Patent Literature 1 discloses a technique/technology of generating a layout by using a reference layout registered in the past. Patent Literature 2 discloses a technique/technology of generating a layout by referring to an actually used layout pattern. Patent Literature 3 discloses a technique/technology of storing data of a model in association with an attribute and presenting a layout corresponding to an attribute of an article to be prepared. Patent Literature 4 discloses a technique/technology of generating a layout by arranging a plurality of contents in a predetermined area.

### CITATION LIST

### Patent Literature

Patent Literature 1: JP2001-109745A

Patent Literature 2: JP5506176B

Patent Literature 3: JP2018-067151A

Patent Literature 4: JP2020-057381A

### SUMMARY

### Technical Problem

In order to properly layout documents, it is desirable to learn a model for generating the layout in advance. Each of the cited documents, however, has insufficient discussion on the learning of the layout, and there is room for improvement.

It is an example object of this disclosure to provide a learning system, a learning method, and a computer program that are capable of solving the problems described above.

### Solution to Problem

A learning system according to an example aspect of this disclosure includes: a training data generation unit that extracts a constraint of an inputted layout and that generates constrained training data; and a learning unit that learns, by using Generative Adversarial Networks, a learning unit that generates a generated layout by using a random number and a layout discrimination unit that discriminates the generated layout and the constrained training data.

A learning method according to an example aspect of this disclosure includes: extracting a constraint of an inputted layout and generating constrained training data; and learning, by using Generative Adversarial Networks, a learning unit that generates a generated layout by using a random number and a layout discrimination unit that discriminates the generated layout and the constrained training data.

A computer program according to an example aspect of this disclosure operates a computer: to extract a constraint of an inputted layout and generating constrained training data; and to learn, by using Generative Adversarial Networks, a learning unit that generates a generated layout by using a random number and a layout discrimination unit that discriminates the generated layout and the constrained training data.

### Effect of the Invention

According to the learning system, the learning method, and the computer program in the respective aspects described above, it is possible to properly learn a layout in a document or the like.

### BRIEF DESCRIPTION OF DRAWINGS

FIG. 1 is a block diagram illustrating a hardware configuration of a learning system according to a first example embodiment.

FIG. 2 is a block diagram illustrating a functional configuration of the learning system according to the first example embodiment.

FIG. 3 is a flowchart illustrating a flow of operation at the time of learning of the learning system according to the first example embodiment.

FIG. 4 is a flowchart illustrating a flow of a process of learning a layout generator in the learning system according to the first example embodiment.

FIG. 5 is a flowchart illustrating a flow of a process of learning a layout discriminator in the learning system according to the first example embodiment.

FIG. 6 is a conceptual diagram illustrating a method of generating constrained training data by using a constraint based on a size of a column design.

FIG. 7 is a conceptual diagram illustrating a method of generating constrained training data by using a constraint based on a width of a line.

FIG. 8 is a block diagram illustrating a functional configuration of a learning system according to a third example embodiment.

FIG. 9 is a conceptual diagram illustrating an example of vectorization of conditions.

FIG. 10 is a flowchart illustrating a flow of a process of learning a layout generator in the learning system according to the third example embodiment.

FIG. 11 is a conceptual diagram illustrating a difference comparison between an original layout and a layout after reduction and enlargement.

FIG. 12 is a graph illustrating a method of determining a reduction size on the basis of a difference in the layout.

### DESCRIPTION OF EXAMPLE EMBODIMENTS

Hereinafter, a learning system, a learning method, and a computer program according to example embodiments will be described with reference to the drawings.

### First Example Embodiment

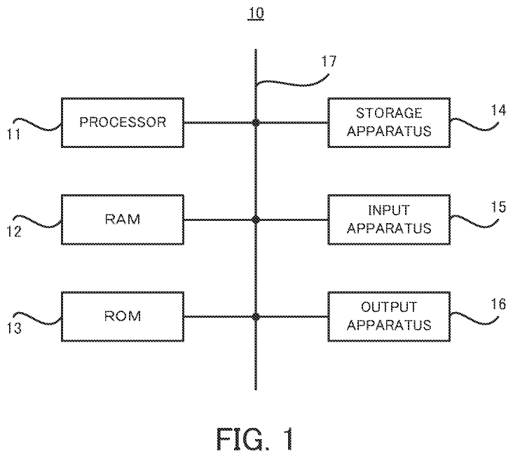

A learning system according to a first example embodiment will be described with reference to FIG. 1 to FIG. 5.

### Hardware Configuration

First, a hardware configuration of the learning system according to the first example embodiment will be described with reference to FIG. 1. FIG. 1 is a block diagram illustrating the hardware configuration of the learning system according to the first example embodiment.

As illustrated in FIG. 1, a learning system 10 according to the first example embodiment includes a processor 11, a RAM (Random Access Memory) 12, a ROM (Read Only Memory) 13, and a storage apparatus 14. The learning system 10 may also include an input apparatus 15 and an output apparatus 16. The processor 11, the RAM 12, the ROM 13, the storage apparatus 14, the input apparatus 15, and the output apparatus 16 are connected through a data bus 17.

The processor 11 reads a computer program. For example, the processor 11 is configured to read a computer program stored by at least one of the RAM 12, the ROM 13 and the storage apparatus 14. Alternatively, the processor 11 may read a computer program stored in a computer readable recording medium, by using a not-illustrated recording medium reading apparatus. The processor 11 may obtain (i.e., may read) a computer program from a not-illustrated apparatus disposed outside the learning system 10, through a network interface. The processor 11 controls the RAM 12, the storage apparatus 14, the input apparatus 15, and the output apparatus 16 by executing the read computer program. Especially in this example embodiment, when the processor 11 executes the read computer program, a functional block for learning a layout is realized or implemented in the processor 11. As the processor 11, one of a CPU (Central Processing Unit), a GPU (Graphics Processing Unit), a FPGA (field-programmable gate array), a DSP (Demand-Side Platform), and an ASIC (Application Specific Integrated Circuit) may be used, or a plurality of them may be used in parallel.

The RAM 12 temporarily stores the computer programs executed by the processor 11. The RAM 12 temporarily stores the data that are temporarily used by the processor 11 when the processor 11 executes the computer program. The RAM 12 may be, for example, a D-RAM (Dynamic RAM).

The ROM 13 stores a computer program to be executed by the processor 11. The ROM 13 may otherwise store fixed data. The ROM 13 may be, for example, a P-ROM (Programmable ROM).

The storage apparatus 14 stores the data that are stored for a long term by the learning system 10. The storage apparatus 14 may operate as a temporary storage apparatus of the processor 11. The storage apparatus 14 may include, for example, at least one of a hard disk apparatus, a magneto-optical disk apparatus, a SSD (Solid State Drive), and a disk array apparatus.

The input apparatus 15 is an apparatus that receives an input instruction from a user of the learning system 10. The input apparatus 15 may include, for example, at least one of a keyboard, a mouse, and a touch panel.

The output apparatus 16 is an apparatus that outputs information about the learning system 10, to the outside. For example, the output apparatus 16 may be a display apparatus (e.g., a display) that is configured to display the information about the learning system 10.

### Functional Configuration

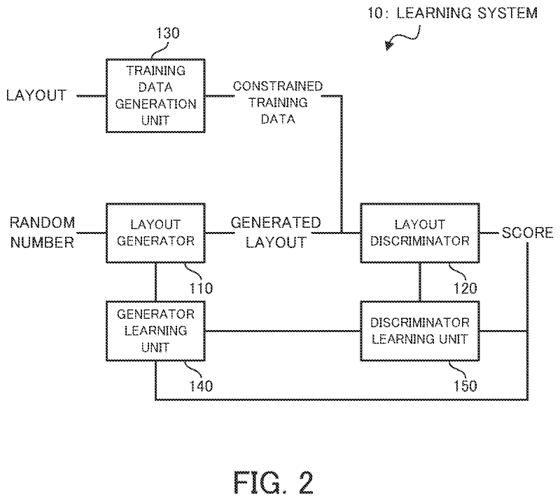

Next, a functional configuration of the learning system 10 according to the first example embodiment will be described with reference to FIG. 2. FIG. 2 is a block diagram illustrating the functional configuration of the learning system according to the first example embodiment.

In FIG. 2, the learning system 10 according to the first example embodiment is configured as a system that learns a layout generator 110 and a layout discriminator 120 by using Generative Adversarial Networks (GAN). The layout generator 110 includes a neural network, and generates a layout (e.g., a layout indicating placement positions of a sentence, a headline, an image, and the like in a document) by using a random number (specifically, a random number vector). The layout discriminator 120 includes a neural network as in the layout generator 110, and discriminates between an inputted layout that is inputted as training data and a generated layout that is generated by the layout generator 110 (e.g., outputs a score indicating a discrimination result). The structure of the respective neural networks that constitute the layout generator 110 and the layout discriminator 120 is not particularly limited.

The learning system 10 includes, as processing blocks for realizing its functions, a training data generation unit 130, a generator learning unit 140, and a discriminator learning unit 150. The training data generation unit 130, the generator learning unit 140, and the discriminator learning unit 150 may be realized or implemented by the processor 11 (see FIG. 1), for example.

The training data generation unit 130 is configured to generate constrained training data from the inputted layout (e.g., an image indicating the layout). When generating the constrained training data, the training data generation unit 130 extracts a constraint of the inputted layout (i.e., a rule specific to the layout) and generates the constrained training data on the basis of the constraint. The constraint of the layout may be automatically extracted from the inputted layout by the training data generation unit 130, or may be extracted in advance as a preset condition together with the layout to be inputted. Since the constrained training data are generated on the basis of such a constraint, the constrained training data have less degree of freedom, compared with those generated without the constraint.

The generator learning unit 140 is configured to optimize the layout generator 110. More specifically, the generator learning unit 140 performs optimization by updating a parameter of the neural network that constitutes the layout generator 110. The generator learning unit 140 learns the layout generator 110 by using the Generative Adversarial Networks. A learning operation performed by the generator learning unit 140 will be described in detail in an explanation of the operation described below.

The discriminator learning unit 150 is configured to optimize the layout discriminator 120. More specifically, the discriminator learning unit 150 performs optimization by updating a parameter of the neural network that constitutes the layout discriminator 120. The discriminator learning unit 150 learns the layout discriminator 120 by using the Generative Adversarial Networks, together with the generator learning unit 140. A learning operation performed by the discriminator learning unit 150 will be described in detail in an explanation of the operation described below.

### Operation in Learning

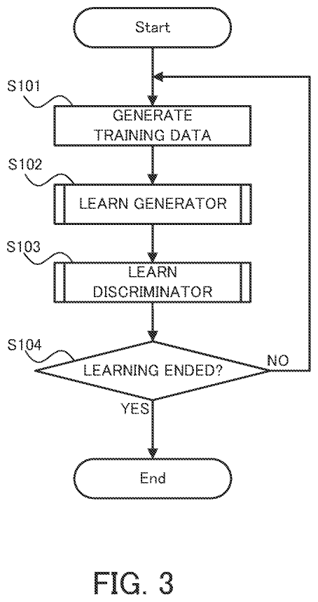

Next, an operation at the time of learning of the learning system 10 according to the first example embodiment will be described with reference to FIG. 3. FIG. 3 is a flowchart illustrating a flow of the operation at the time of learning of the learning system according to the first example embodiment.

As illustrated in FIG. 3, in operation of the learning system 10 according to the first example embodiment (i.e., in the learning operation), first, the training data generation unit 130 extracts the constraint from the inputted layout and generates the constrained training data (step S101). A specific method of generating the constrained training data will be described in detail in other example embodiments.

Subsequently, the generator learning unit 140 performs a process of learning the layout generator 110 (step S102). Furthermore, the discriminator learning unit 150 performs a process of learning the layout discriminator 120 (step S103). The processes of learning the generator learning unit 140 and the discriminator learning unit 150 are performed by the Generative Adversarial Networks.

Subsequently, when the learning system 10 according to the first example embodiment determines that the learning processes performed by the generator learning unit 140 and the discriminator learning unit 150 are ended (step S104: YES), a series of learning operation steps is ended. On the other hand, when it is determined that the learning processes performed by the generator learning unit 140 and the discriminator learning unit 150 are not ended (the step S104: NO), the learning operation steps are repeated from the step S101. The learning system 10 may determine that the learning processes performed by the generator learning unit 140 and the discriminator learning unit 150 are ended when the number of repetitions of the step S101 to the step 5103 reaches a predetermined number of times (e.g., one hundred thousand times).

### Learning Layout Generator

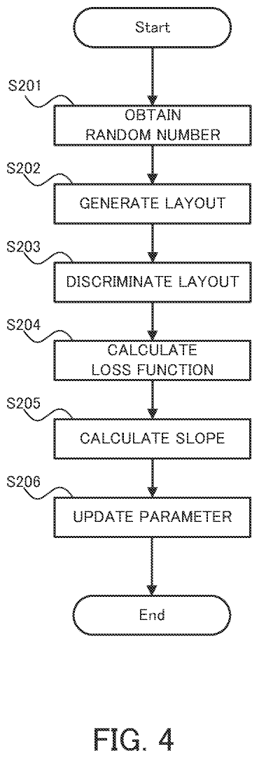

Next, with reference to FIG. 4, the process of learning the layout generator 110 (i.e., the step S102 in FIG. 3) will be described in detail. FIG. 4 is a flowchart illustrating a flow of the process of learning the layout generator in the learning system according to the first example embodiment.

As illustrated in FIG. 4, in the process of learning the layout generator 110, first, the layout generator 110 obtains the random number vector (e.g., the one that is created from a Gaussian random number) (step S201), and generates the generated layout from the random number vector (step S202). Then, the layout discriminator 120 discriminates the generated layout and outputs the score indicating the discrimination result (step S203).

Subsequently, the generator learning unit 140 calculates a loss function such that the discrimination result by the layout discriminator 120 approaches a correct-answer layout (step S204). That is, the generator learning unit 140 calculates the loss function so as to deceive the layout discriminator 120 (i.e., to make the layout discriminator 120 believe or treat the generated layout as the correct-answer layout).

The generator learning unit 140 calculates a slope of each parameter of the neural network that constitutes the layout generator 110 from the loss function, by using an error back propagation method (step S205). Then, the generator learning unit 140 updates each parameter of the neural network that constitutes the layout generator 110, by using the calculated slope (step S206).

In the series of processing steps, one batch of the learning process by the generator learning unit 140 is ended. When the process of learning the layout generator 110 by the generator learning unit 140 is ended, the process is moved to the process of learning the layout discriminator 120 by the discriminator learning unit 150.

### Learning Layout Discriminator

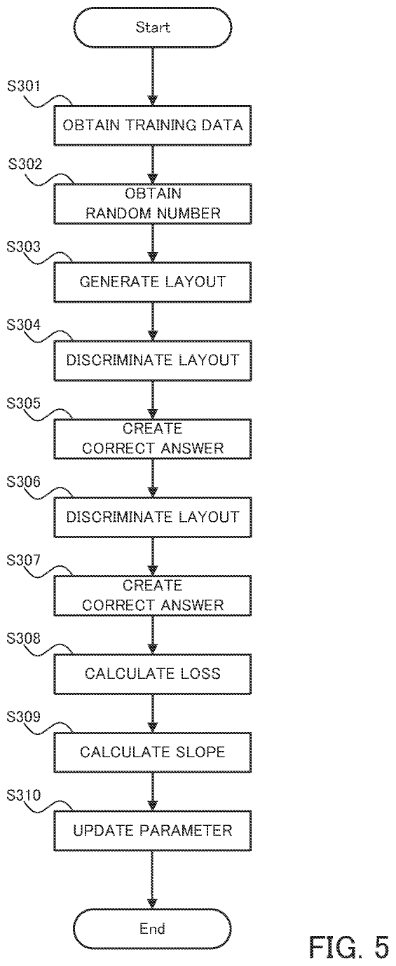

Next, with reference to FIG. 5, the process of learning the layout discriminator 120 (i.e., the step S103 in FIG. 3) will be described in detail. FIG. 5 is a flowchart illustrating a flow of the process of learning the layout discriminator in the learning system according to the first example embodiment.

As illustrated in FIG. 5, in the process of learning the layout discriminator 120, first, the discriminator learning unit 150 obtains information about the correct-answer layout from the training data (step S301). The discriminator learning unit 150 obtains only one batch size of information about the correct-answer layout.

Subsequently, the layout generator 110 obtains the random number vector (step S302), and generates the generated layout from the random number vector (step S303). Then, the layout discriminator 120 discriminates the generated layout and outputs the score indicating the discrimination result (step S304). The discriminator learning unit 150 creates the loss function such that the discrimination result by the layout discriminator 120 in this case approaches the generated layout (step S305).

In the process of learning the layout discriminator 120, the layout discriminator 120 further discriminates the constrained training data (i.e., the correct-answer layout) and outputs the score indicating the discrimination result (step S306). Then, the discriminator learning unit 150 creates the loss function such that the discrimination result by the layout discriminator 120 in this case approaches the correct-answer layout (step S307).

Subsequently, the discriminator learning unit 150 calculates the loss function such that the discrimination result of the generated layout is the generated layout and the discrimination result of the correct-answer layout is the correct-answer layout (step S308). That is, the discriminator learning unit 150 calculates the loss function such that the layout discriminator 120 may discriminate between the generated layout and the correct-answer layout.

The discriminator learning unit 150 calculates a slope of each parameter of the neural network that constitutes the layout discriminator 120 from the loss function, by using the error back propagation method (step S309). Then, the discriminator learning unit 150 updates each parameter of the neural network that constitutes the layout discriminator 120, by using the calculated slope (step S310).

In the series of processing steps, one batch of the learning process by the discriminator learning unit 150 is ended. After the process of learning the layout discriminator 120 by the discriminator learning unit 150 is ended, a following batch of the learning process is performed. That is, as described in the flowchart in FIG. 3, the processes of learning the layout generator 110 and the layout discriminator 120 are repeated until all the learning processes are ended.

In the processes of learning the layout generator 110 and the layout discriminator 120, for example, binary cross entropy is used as the loss function. The loss function, however, is not particularly limited, and another loss function may be used.

### Technical Effect

Next, a technical effect obtained by the learning system 10 according to the first example embodiment will be described.

As described in FIG. 1 to FIG. 5, in the learning system 10 according to the first example embodiment, the layout generator 110 and the layout discriminator 120 are learned by the Generative Adversarial Networks by using the constrained training data. Especially, since the constrained training data are generated on the basis of the constraint specific to the layout, the constrained training data have less degree of freedom, compared with those generated without the constraint. Therefore, the use of the constrained training data makes it possible to perform the learning process, more efficiently, compared with the case of using the training data without the constraint.

### Second Example Embodiment

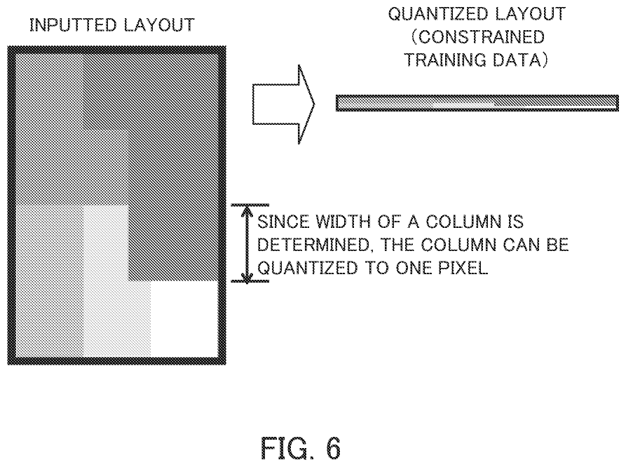

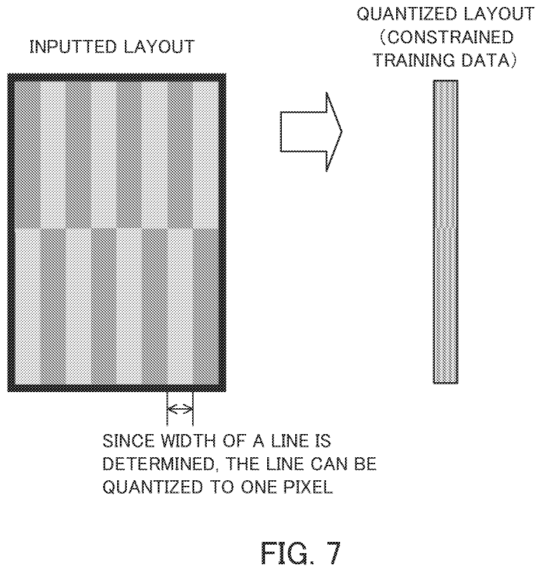

The learning system 10 according to a second example embodiment will be described with reference to FIG. 6 and FIG. 7. The second example embodiment describes a specific example of the constraint extracted at the time of generating the training data, and may be the same as the first example embodiment in the operation and configuration (e.g., see FIG. 1 to FIG. 5). For this reason, the parts that differ from the first example embodiment will be described in detail below, and a description of the overlapping parts will be omitted as appropriate.

### Constraint Based on Column Design

First, with reference to FIG. 6, a constraint based on a column design and the training data generated on the basis of the constraint will be specifically described. FIG. 6 is a conceptual diagram illustrating a method of generating the constrained training data by using the constraint based on a size of the column design.

As illustrated in FIG. 6, in the layout of articles in a newspaper, a magazine, or the like, the column design of a predetermined size is set in advance. In this case, it is possible to generate the constrained training data on the basis of the constraint corresponding to the size of the column design (i.e., a width of a column). Specifically, when the size of the column design is determined in advance, the constrained training data can be generated as a quantized layout in which one column is quantized to one pixel.

### Constraint Based on With of Line

Next, a constraint based on a width of a line and the training data generated on the basis of the constraint will be specifically described with reference to FIG. 7. FIG. 7 is a conceptual diagram illustrating a method of generating the constrained training data by using the constraint based on the width of the line.

As illustrated in FIG. 7, in the layout of articles in a newspaper, a magazine, or the like, the width of the line (in other words, the width of a character) is set in advance. In this case, it is possible to generate the constrained training data on the basis of the constraint corresponding to the width of the line. Specifically, when the width of the line is determined in advance, the constrained training data can be generated as a quantized layout in which one line is quantized to one pixel.

### Technical Effect

Next, a technical effect obtained by the learning system 10 according to the second example embodiment will be described.

As described in FIG. 6 and FIG. 7, in the learning system 10 according to the second example embodiment, the constrained training data are generated on the basis of the constraints corresponding to the size of the column design and the width of the line. Therefore, it is possible to perform the learning process, efficiently, in the learning of the layout in a newspaper, a magazine, or the like.

### Third Example Embodiment

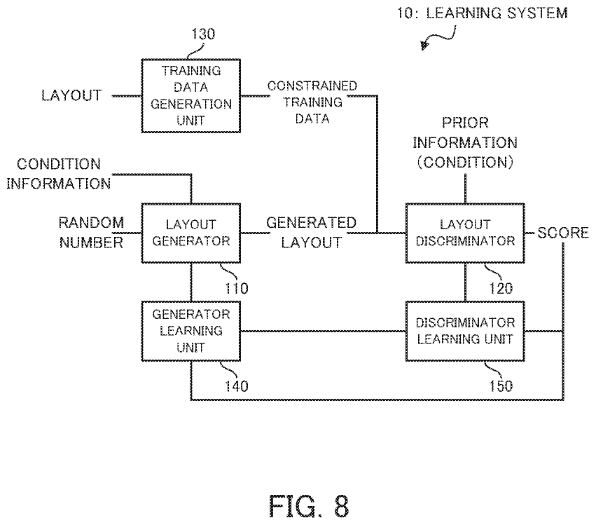

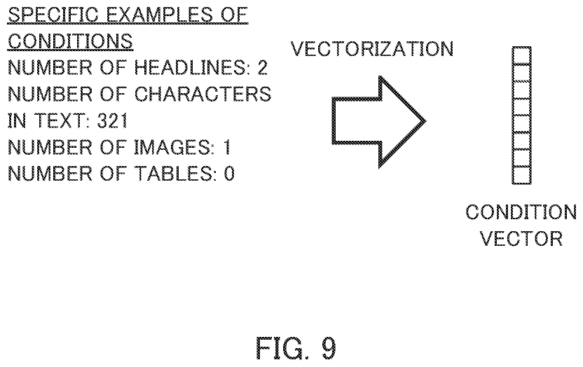

The learning system 10 according to a third example embodiment will be described with reference to FIG. 8 and FIG. 9. The third example embodiment is partially different from the first and second example embodiments only in the configuration and operation (specifically, in that the condition is inputted), and is generally the same in other parts. For this reason, the parts that differ from the example embodiments described above will be described in detail below, and a description of the overlapping parts will be omitted as appropriate.

### Functional Configuration

First, a functional configuration of the learning system 10 according to the third example embodiment will be described with reference to FIG. 8. FIG. 8 is a block diagram illustrating the functional configuration of the learning system according to the third example embodiment.

As illustrated in FIG. 8, the learning system 10 according to the third example embodiment is configured to performs the processes of learning the layout generator 110 and the layout discriminator 120 by using Conditional Generative Adversarial Networks (CGAN). Specifically, not only the random number but also a condition information is configured to be inputted to the layout generator 110. In this case, the layout generator 110 generates the generated layout by inputting the random number and the condition information to the neural network. Furthermore, the condition information is configured to be inputted to the layout discriminator 120 as a prior information. In this case, the layout discriminator 120 uses the condition information to discriminate the layout.

### Vectorization of Conditions

Next, the vectorization of conditions will be specifically described with reference to FIG. 9. FIG. 9 is a conceptual diagram illustrating an example of vectorization of the conditions.

As illustrated in FIG. 9, suppose that the number of headlines “2”, the number of characters in the text “321”, the number of images “1”, and the number of tables “0” are inputted as the condition information, for example. In this case, the condition information is vectorized and is processed as a condition vector (a multi-dimensional vector). The above-described condition information is merely an example, and various information about an article may be inputted as the condition information. For example, a priority order of an article (i.e., a degree indicating how much the article is highlighted) may be used as the condition information. The condition information may be a combination of a plurality of conditions as in the example of FIG. 9, or may include only one condition.

### Learning Layout Generator

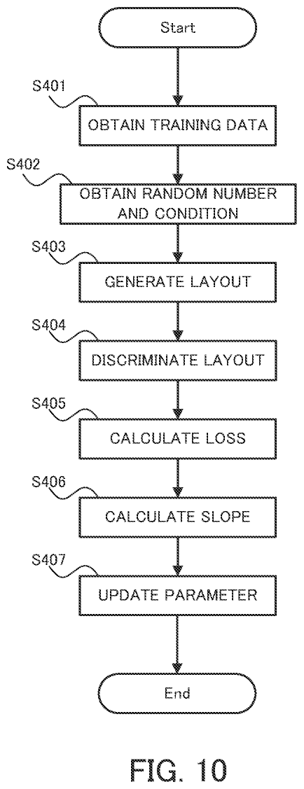

Next, with reference to FIG. 10, the process of learning the layout generator 110 according to the third example embodiment will be described in detail. FIG. 10 is a flowchart illustrating a flow of the process of learning the layout generator in the learning system according to the third example embodiment.

As illustrated in FIG. 10, in the process of learning the layout generator 110, first, the generator learning unit 140 obtains information about the correct-answer layout (i.e., the inputted layout) from the training data (step S401). The generator learning unit 140 obtains only one batch size of information about the correct-answer layout.

Subsequently, the layout generator 110 obtains the random number vector and the condition information (step S402). The layout generator 110 generates the generated layout on the basis of the obtained random number vector and the obtained condition information (step S403). Then, the layout discriminator 120 discriminates the generated layout by using the condition information and outputs the score indicating the discrimination result (step S404).

Subsequently, the generator learning unit 140 calculates the loss function such that the discrimination result by the layout discriminator 120 approaches the correct-answer layout (step S405). That is, the generator learning unit 140 calculates the loss function so as to deceive the layout discriminator 120 (i.e., to make the layout discriminator 120 believe or treat the generated layout as the correct-answer layout).

The generator learning unit 140 calculates the slope of each parameter of the neural network that constitutes the layout generator 110 from the loss function, by using the error back propagation method (step S406). Then, the generator learning unit 140 updates each parameter of the neural network that constitutes the layout generator 110, by using the calculated slope (step S407).

In the series of processing steps, one batch of the learning process by the generator learning unit 140 is ended. When the process of learning the layout generator 110 by the generator learning unit 140 is ended, the process is moved to the process of learning the layout discriminator 120 by the discriminator learning unit 150.

The process of learning the layout discriminator 120 according to the third example embodiment may be the same as that in the second example embodiment (see FIG. 5). For this reason, a description of the process of learning the layout discriminator 120 according to the third example embodiment will be omitted.

### Technical Effect

Next, a technical effect obtained by the learning system 10 according to the third example embodiment will be described.

As described in FIG. 8 to FIG. 10, in the learning system 10 according to the third example embodiment, the learning process is performed by the Conditional Generative Adversarial Networks. Therefore, it is possible to perform the learning process, more efficiently, as compared with the case of performing the learning process by using Generative Adversarial Networks that are not conditional as in the first example embodiment, for example.

### Fourth Example Embodiment

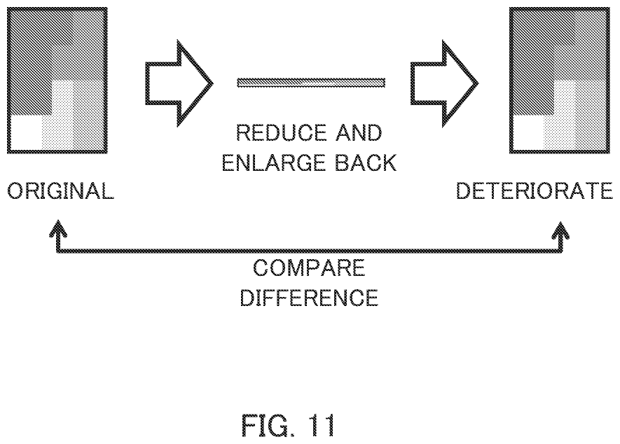

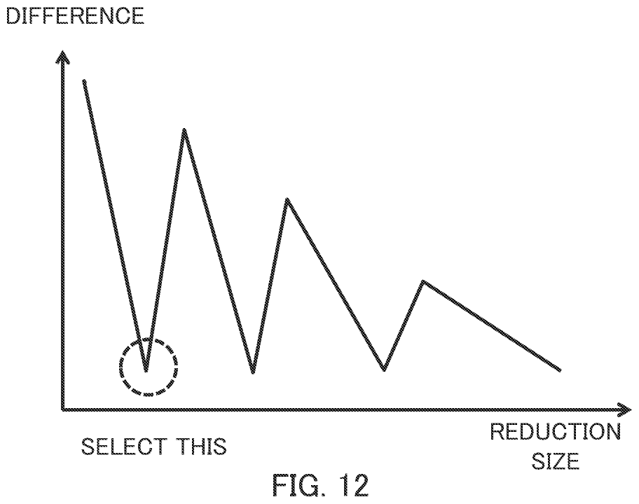

The learning system 10 according to a fourth example embodiment will be described with reference to FIG. 11 and FIG. 12. The fourth example embodiment describes the method of generating the constrained training data in each example embodiment described above, and may be the same as each example embodiment described above in the configuration and operation. For this reason, the parts that differ from the example embodiments described above will be described in detail below, and a description of the overlapping parts will be omitted as appropriate.

### Difference Value Comparison

First, with reference to FIG. 11, a process of determining a layout size in generating the constrained training data will be described with reference to FIG. 11. FIG. 11 is a conceptual diagram illustrating a difference comparison between an original layout and a layout after reduction and enlargement.

In FIG. 11, suppose that a layout that is inputted to the learning system 10 (specifically, the training data generation unit 130) is a segmentation image in which an ID of an article is allocated to each pixel. In this case, the training data generation unit 130 reduces the segmentation image longitudinally by using Nearest Neighbor, then enlarges it to an original size by the Nearest Neighbor, and then, compares a difference between an original image and an image after reduction and enlargement. More specifically, the training data generation unit 130 obtains, as a difference value, a sum of the number of pixels of discrepancy between the original image and the image after reduction and enlargement. The training data generation unit 130 repeats the process of obtaining the difference value in such a manner that a reduction size is reduced by using a continuous value. The training data generation unit 130 determines the reduction size of the segmentation image (in other words, an image size of the constrained training data) on the basis of the difference value obtained by such a process.

### Determination of Reduction Size

Next, a method of determining the reduction size on the basis of the difference value will be described with reference to FIG. 12. FIG. 12 is a graph illustrating the method of determining the reduction size on the basis of the difference value.

As illustrated in FIG. 12, if the difference value is repeatedly obtained between the original image and the image after reduction and enlargement, the difference value suddenly decreases when it reaches a certain size (see a part surrounded by a broken line in FIG. 12). The training data generation unit 130 determines the size when the difference value suddenly decreases, to be the smallest reduction size of the segmentation image (i.e., the image size of the constrained training data).

The process of determining the reduction size may be performed by laterally reducing and enlarging the segmentation image. In other words, the segmentation image may be reduced laterally by the Nearest Neighbor, then may be enlarged to the original size by the Nearest Neighbor, and a lateral reduction size may be determined from the difference value between the original image and the image after reduction and enlargement. The reduction size of the segmentation image may be determined for only one of longitudinal and the lateral directions, or may be determined for both the longitudinal and lateral directions. Several pixels of the original image may be cut as an offset before being reduced or enlarged. For example, when pixels are arranged like 00111000111, the first two pixels are removed as the offset before being reduced to three pixels (101). The subsequent enlargement allows the same arrangement between the original image (111000111) and the pixels after the offset (but does not allow the same arrangement when the offset is 0).

The process of determining the image size of the constrained training data is performed, for example, by using a plurality of data that are randomly sampled from all the data in an initialization part of the learning operation. After determining the smallest reduction size, the training data generation unit 130 performs a process of reducing the inputted segmentation image, with the smallest reduction size as a fixed value.

### Technical Effect

Next, a technical effect obtained by the learning system 10 according to the fourth example embodiment will be described.

As described with reference to FIG. 11 and FIG. 12, in the learning system 10 according to the fourth example embodiment, the reduction size of the image is determined on the basis of the difference between the layout image and the image after reduction and enlargement. In this way, it is possible to easily and accurately generate appropriate constrained training data.

### Supplementary Notes

The example embodiments described above may be further described as, but not limited to, the following Supplementary Notes.

### Supplementary Note 1

A learning system described in Supplementary Note 1 is a learning system including: a training data generation unit that extracts a constraint of an inputted layout and that generates constrained training data; and a learning unit that learns, by using Generative Adversarial Networks, a learning unit that generates a generated layout by using a random number and a layout discrimination unit that discriminates the generated layout and the constrained training data.

### Supplementary Note 2

A learning system described in Supplementary Note 2 is the learning system described in Supplementary Note 1, wherein the training data generation unit extracts such a constraint that a longitudinal length of a layout is quantized in accordance with a size of a column design, and generates the constrained training data.

### Supplementary Note 3

A learning system described in Supplementary Note 3 is the learning system described in Supplementary Note 1 or 2, wherein the training data generation unit extracts such a constraint that a lateral length of a layout is quantized in accordance with a width of a line, and generates the constrained training data.

### Supplementary Note 4

A learning system described in Supplementary Note 4 is the learning system described in any one of Supplementary Notes 1 to 3, wherein the learning unit performs learning by using Conditional Generative Adversarial Networks.

### Supplementary Note 5

A learning system described in Supplementary Note 5 is the learning system described in Supplementary Note 4, wherein a condition of the Conditional Generative Adversarial Networks is at least one of a length of an article included in the layout, a priority order of the article, a number of images associated with the article, and a number of headlines associated with the article.

### Supplementary Note 6

A learning system described in Supplementary Note 6 is the learning system described in any one of Supplementary Notes 1 to 5, wherein the training data generation unit generates the constrained training data by reducing a layout image indicating the layout on the basis of the constraint.

### Supplementary Note 7

A learning system described in Supplementary Note 7 is the learning system described in Supplementary Note 6, wherein the training data generation unit determines a reduction size of the layout image on the basis of a difference between the layout image and an image that is obtained by reducing the layout image and then enlarging it to an original size.

### Supplementary Note 8

A learning system described in Supplementary Note 8 is the learning system described in any one of Supplementary Notes 1 to 7, wherein the layout is a layout in a newspaper or a magazine.

### Supplementary Note 9

A learning method described in Supplementary Note 9 is a learning method including: extracting a constraint of an inputted layout and generating constrained training data; and learning, by using Generative Adversarial Networks, a learning unit that generates a generated layout by using a random number and a layout discrimination unit that discriminates the generated layout and the constrained training data.

### Supplementary Note 10

A computer program described in Supplementary Note 10 is a computer program that operates a computer: to extract a constraint of an inputted layout and to generate constrained training data; and to learn, by using Generative Adversarial Networks, a learning unit that generates a generated layout by using a random number and a layout discrimination unit that discriminates the generated layout and the constrained training data.

### Supplementary Note 11

A recording medium described in Supplementary Note 11 is a recording medium on which the computer program described in Supplementary Note 10 is recorded.

This disclosure is not limited to the above-described examples and is allowed to be changed, if desired, without departing from the essence or spirit of the invention which can be read from the claims and the entire specification. A learning system, a learning method, and a computer program with such modifications are also intended to be within the technical scope of this disclosure.

### DESCRIPTION OF REFERENCE CODES

10 Learning system

11 Processor

110 Layout generator

120 Layout discriminator

130 Training data generation unit

140 Generator learning unit

150 Discriminator learning unit

What is claimed is:

1. A learning system comprising:
at least one memory that is configured to store instructions; and
at least one first processor that is configured to execute the instructions to
extract a constraint of an inputted layout and generate constrained training data; and
learn, by using Generative Adversarial Networks, a layout generator that generates a generated layout by using a random number and a layout discriminator that discriminates the generated layout and the constrained training data.

2. The learning system according to claim 1, wherein the at least one first processor that is configured to execute the instructions to extract such a constraint that a longitudinal length of a layout is quantized in accordance with a size of a column design, and generate the constrained training data.

3. The learning system according to claim 1, wherein the at least one first processor that is configured to execute the instructions to extract such a constraint that a lateral length of a layout is quantized in accordance with a width of a line, and generate the constrained training data.

4. The learning system according to claim 1, wherein the at least one first processor that is configured to execute the instructions to perform learning by using Conditional Generative Adversarial Networks.

5. The learning system according to claim 4, wherein a condition of the Conditional Generative Adversarial Networks is at least one of a length of an article included in the layout, a priority order of the article, a number of images associated with the article, and a number of headlines associated with the article.

6. The learning system according to claim 1, wherein the at least one first processor that is configured to execute the instructions to generate the constrained training data by reducing a layout image indicating the layout on the basis of the constraint.

7. The learning system according to claim 6, wherein the at least one first processor that is configured to execute the instructions to determine a reduction size of the layout image on the basis of a difference between the layout image and an image that is obtained by reducing the layout image and then enlarging it to an original size.

8. The learning system according to claim 1, wherein the layout is a layout in a newspaper or a magazine.

9. A learning method comprising:
extracting a constraint of an inputted layout and generating constrained training data; and
learning, by using Generative Adversarial Networks, a layout generator that generates a generated layout by using a random number and a layout discriminator that discriminates the generated layout and the constrained training data.

10. A non-transitory recording medium on which a computer program that allows a computer to execute a learning method is recorded, the learning method comprising:
extracting a constraint of an inputted layout and generating constrained training data; and
learning, by using Generative Adversarial Networks, a layout generator that generates a generated layout by using a random number and a layout discriminator that discriminates the generated layout and the constrained training data.
